(19) United States
(12) Patent Application Publication
(10) Pub. No.: US 2008/0162873 A1
(43) Pub. Date: Jul. 3, 2008

(54) Heterogeneous multiprocessing

(76) Inventors: Vincent J. Zimmer, Federal Way, WA (US); Yufu Li, Shanghai (CN); Michael A. Rothman, Puyallup, WA (US); Burges M. Karkaria, San Jose, CA (US)

Correspondence Address: INTEL CORPORATION;c/o INTELLEVATE, LLC, P.O. BOX 52050, MINNEAPOLIS, MN, 55402, US

(21) Appl. No.: 11/647,501

(22) Filed: Dec. 28, 2006

(51) Int. Cl. G06F 15/76

(52) U.S. Cl. 712/22

(57) ABSTRACT

In some embodiments, the invention involves a system and method to provide maximal boot-time parallelism for future multi-core, multi-node, and many-core systems. In an embodiment, the security (SEC), pre-EFI initialization (PEI), and then driver execution environment (DXE) phases are executed in parallel on multiple compute nodes (sockets) of a platform. Once the SEC/PEI/DXE phases are executed on all compute nodes having a processor, the boot device select (BDS) phase completes the boot by merging or partitioning the compute nodes based on a platform policy. Partitioned compute nodes each run their own instance of EFI. A common memory map may be generated prior to operating system (OS) launch when compute nodes are to be merged. Other embodiments are described and claimed.

### CROSS REFERENCE TO RELATED APPLICATIONS

This application is related to co-owned and co-pending U.S. patent application Ser. No. 11/010,167 (Attorney Docket P20495), entitled “Interleaved Boot Block To Support Multiple Processor Architectures And Method Of Use,” filed by Rahul Khanna, et al. on Dec. 10, 2004 (U.S. Pub. No. US-2006-0129795-A1, Jun. 15, 2006).

This application is also related to co-owned and co-pending U.S. patent application 11/______ (Attorney Docket P24812), entitled “Multi-Socket Boot,” filed concurrently by Zimmer et al.

### FIELD OF THE INVENTION

An embodiment of the present invention relates generally to computing systems and, more specifically, a system and method to enable a multi-processor platform to be configured with heterogeneous processor.

### BACKGROUND INFORMATION

Various mechanisms exist for providing multi-processor capabilities in a platform. Existing systems may utilize coprocessors having a different chip configuration/specification than the central processing unit(s) of a platform. Platforms having multi-processor or multi-core architecture present unique challenges during boot. Platforms having a point to point interconnect (pTp) architecture also require great reliability at boot time.

In the computer hardware industries, microprocessor development and advancement has presented customers with a number of processor architectures and computer systems to choose from. The options available to a customer have grown to allow customers to choose computer systems that have processors better designed to meet their specific needs, from the personal home computer to the network server. And recently to offer customers even further choices, hardware manufacturers have proposed common board computer systems operable across numerous processor architectures. With a modular processor design, a customer could be able to purchase one computer and swap out different processor architectures without needing to replace the entire system, the processor board, or processor chipsets. There are limitations effecting the implementation of such common board systems.

Different processor architectures operate under different protocols, for example, executing instructions of different, incapable word lengths, and in different, incapable ways. The Pentium® and Xeon® Processor Family (XPF) of microprocessors (available from Intel Corporation, Santa Clara, Calif.) are 16, 32 and 64 bit processors, while the Itanium® Processor Family (IPF) of microprocessors (also available from Intel Corporation) comprises 64 bit processors. These two processor families (i.e., XPF and IPF) are distinguished by their instruction set architectures (ISA's). The Xeon® processors support the 16-bit, 32-bit, and 64-bit instructions (known as real-mode, IA-32 protected mode, and Intel64, or x64, long-mode, respectively). Whereas the Itanium® processors support the IA-64 instruction set (although Itanium® processors can emulate the aforementioned Xeon® ISA in ‘software’). Itanium® processors use a VLIW (Very-Long Instruction Word) and instructions are ‘bundles’ of 4-opcodes that are processed in parallel; the specific VLIW implementation is called ‘EPIC.’ Intel64 ISA processes instructions serially (although the internal micro-architecture may do speculative, out-of-order, processing, etc.). Also, Intel64 ISA has a paucity of registers (a dozen integer registers exposed to the programmer), whereas Itanium® has 128 general purpose registers and 128 floating point registers. Register access is preferred over memory access because of the cost of latency to main memory. As such, Itanium® processors comprise a much more scalable architecture and have higher ILP—instruction level parallelism. A disadvantage of Itanium® processors is that they use a newer ISA, whereas the IA32/Intel64 ISA has been around for years and has lots of available software. And while common board, modular firmware has been proposed for swapping between these processors in a single computer system, such swap out is hindered by the vastly different boot procedures required for starting up a system under each environment.

The boot environment for each processor architecture requires execution of a different basic input/output system (BIOS) at system startup. BIOS is the essential system code or instructions used to control system configuration and to load the operating system for the computing system. BIOS provides the first instructions a computing system executes when it is first turned on, BIOS, which is typically stored in a flash memory, is executed each time the system is started and executes drivers required for the computer system prior to execution of the operating system abstraction.

Processor architecture may have a different flash memory map for its BIOS. The flash maps for an IA-32 BIOS are different from that of an IPF BIOS, for example. Since the flash update procedures rely on flash maps which describe the flash consumption, BIOS updates across processor architectures are not available for the common board/socket/module systems. In other words, while common board designs may allow swap out of the microprocessor, one processor architecture BIOS may not be swapped out for another. Furthermore, the topmost flash portions of the boot block code for the BIOS may be protected and may not be updated, or changed, to another processor architecture BIOS. In short, while common board systems offer the modularity of microprocessors, they do not offer modularity of the BIOS required specific to these microprocessors. Common board/socket/module system architectures would, therefore, benefit from an ability to efficiently move from one BIOS to another, whenever the system microprocessor is changed.

Processors in a multi-processor (MP) system may be connected with a multi-drop bus or a point-to-point interconnection network. A point-to-point interconnection network may provide fill connectivity in which every processor is directly connected to every other processor in the system. A point-to-point interconnection network may alternatively provide partial connectivity in which a processor reaches another processor by routing through one or more intermediate processors. A large-scale, partitionable, distributed, symmetric multiprocessor (SMP) system may be implemented using AMD® Opteron™ processors as building blocks. Glueless SMP capabilities of Opteron processors may scale from 8 sockets to 32 sockets. Implementations may use a high-throughput, coherent HyperTransport™ (cHT) protocol handling using multiple protocol engines (PE) and a pipelined design. Other implementations may use processors available for future systems from Intel Corporation that utilize a pTp interconnect in a platform having extensible firmware interface (EFI) architecture.

Cache coherency enables the disparate processors to communicate with each other, for instance, to send commands and results back and forth, and share memory maps. Processors of unlike architectures, often use unlike, and incompatible, cache messaging protocols.

Each processor in a MP system typically has a local cache to store data and code most likely to be reused. To ensure cache coherency, processors need to be informed of any transactions that may alter the coherency states of the data items in their local caches. One approach to cache coherency is directory-based where a centralized directory keeps track of all memory transactions that may alter the coherency states of the cached items. A coherency state indicates whether a data item is modified by a processor (the “M” state), exclusively owned by a processor (the “E” state), shared by multiple processors (the “5” state), or invalidated (the “I” state). The implementation of a directory often incurs substantial hardware cost.

Another approach to cache coherency is based on message exchanges among processors. For example, processors may exchange snoop messages to notify other processors of memory transactions that may alter the coherency states of cached data items. In a bus-connected MP system when a processor fetches a data item from main memory, all of the other processors can snoop the common bus at the same time. In a point-to-point interconnection network, a processor sends snoop messages to all the other processors when it conducts a memory transaction, Snoop messages can be sent directly from one processor to all the other processors in a fully-connected point-to-point interconnection network. However, to save hardware cost, a typical point-to-point interconnection network often provides partial connectivity which does not provide direct links between all processors.

Existing MP platforms where the processors are linked with a pTp or cHT protocol require homogeneous processor types. In other words, each processing node in the platform must be of the same type in order to boot properly. In future systems, it may be desirable to be able to mix and match various types of processors on the same MP platform. However, existing systems are unable to process more than one BIOS at a time to accommodate heterogeneous systems.

### BRIEF DESCRIPTION OF THE DRAWINGS

The features and advantages of the present invention will become apparent from the following detailed description of the present invention in which:

FIG. 1 is a protocol architecture as utilized by one embodiment;

FIG. 2 is a block diagram of an apparatus for a physical interconnect utilized in accordance with the claimed subject matter;

FIGS. 3A-C are multiple embodiments of a system as utilized by multiple embodiments;

FIG. 4 is a block diagram showing the flow of execution of a system according to an embodiment of the invention;

FIG. 5 illustrates an exemplary four-socket system having heterogeneous processing nodes, according to embodiments of the invention;

FIG. 6 illustrates a timeline with synchronization points illustrating execution of an embodiment of the invention;

FIG. 7 is a block diagram illustrating an exemplary compute node, according to an embodiment of the invention;

FIG. 8 illustrates an exemplary method for a use of a heterogeneous multi-processing platform, according to an embodiment of the invention; and

FIG. 9 illustrates a comparison of a single ISA architecture and a dual-ISA architecture platform, according to an embodiment of the invention.

### DETAILED DESCRIPTION

An embodiment of the present invention is a system and method which addresses the problem of how to deploy a heterogeneous multi-processor (MP) and properly boot incompatible BIOS code for the on board processors. Co-pending patent application Ser. No. 11/010,167, entitled “Interleaved Boot Block To Support Multiple Processor Architectures And Method Of Use,” filed by Rahul Khanna, on Dec. 10, 2005 (Pub. No. US-2006-0129795-A1, 15 June 2006) (hereinafter, “Khanna”), describes a method for interleaving a boot block to support multiple processor architectures which may be used in embodiments of the present invention. However, Khanna describes a method for switching processor types, but not a MP platform with multiple processor architectures deployed simultaneously.

A heterogeneous platform may be desirable because some processors may excel at different tasks. For instance, one processor may excel at floating point tasks and another may excel at server-type tasks. It may be more cost efficient to deploy a platform that may be customized for user tasks with a proper mix of processors.

An embodiment of the present invention maintains reasonable boot-times and reliabilities in ever larger system fabrics, such as those enabled by a point to point interconnect (pTp) architecture, having heterogeneous processor architectures. Embodiments of the invention address the scaling problem by leveraging the advances in firmware technology, such as the Intel® Platform Innovation Framework for EFI, and may decompose the boot flow to a local, node level initialization, deferring the “joining” of the system fabric until as late as possible. This joining may be required to build a single-single image, symmetric multiprocessor (SMP) topology. Alternatively, embodiments of the invention will allow for a late decision not to include a node for various policy reasons, i.e., errant node or sequestered node for an embedded IT or classical partitioning scenario. Embodiments of the present invention may use techniques described in co-pending U.S. patent application Ser. No. 11/______ (Attorney Docket P24812), entitled “Multi-Socket Boot,” by Zimmer et al., filed concurrently, to parallelize the boot phases over processors.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

For purposes of explanation, specific configurations and details are set forth in order to provide a thorough understanding of the present invention. However, it will be apparent to one of ordinary skill in the art that embodiments of the present invention may be practiced without the specific details presented herein. Furthermore, well-known features may be omitted or simplified in order not to obscure the present invention. Various examples may be given throughout this description. These are merely descriptions of specific embodiments of the invention. The scope of the invention is not limited to the examples given.

An exemplary method, apparatus, and system for system level initialization for a high speed point to point network (pTp) are described. In the following description, for purposes of explanation, numerous details are set forth in order to provide a thorough understanding of the present invention. However, it will be apparent to one skilled in the art that these specific details are not required in order to practice the present invention.

An area of current technological development relates to reliability, availability, and serviceability (RAS). Current systems based on the Front Side Bus (FSB) architecture do not permit hot plug of an individual bus component. Likewise, the current systems suffer from pin limitation, due to conveying initialization values and also suffer from performing multiple warm resets due to initial Power-On Configuration (POC) values are incorrect.

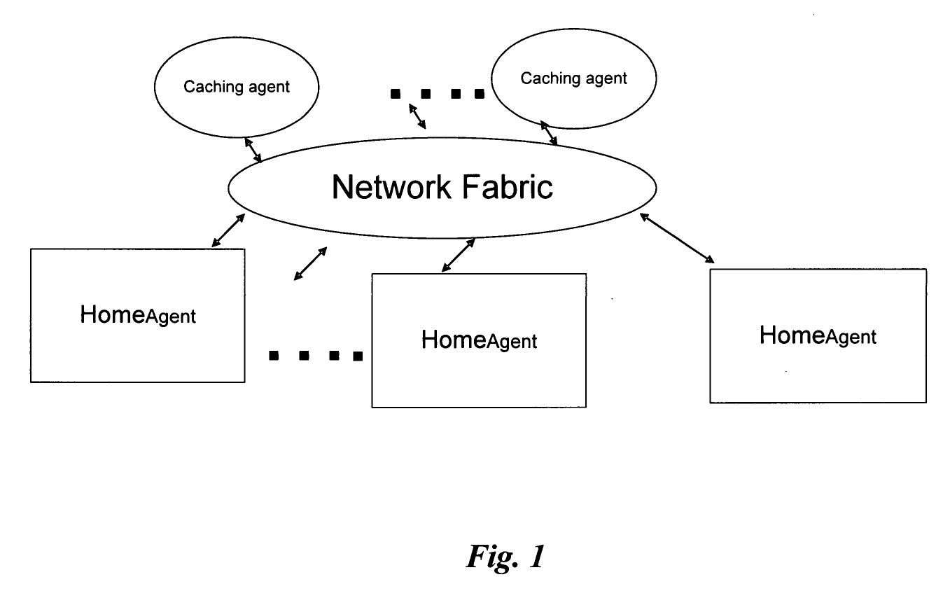

In an embodiment, the pTp architecture supports a layered protocol scheme, which is discussed further, below. FIG. 1 illustrates one example of a cache coherence protocol's abstract view of the underlying network.

FIG. 1 is a protocol architecture as utilized by one embodiment. The architecture depicts a plurality of caching agents and home agents coupled to a network fabric. For example, the network fabric adheres to a layered protocol scheme and may comprise either or all of: a link layer, a physical layer, a protocol layer, a routing layer, or a transport layer. The fabric facilitates transporting messages from one protocol (home or caching agent) to another protocol for a point to point network. In one aspect, the figure depicts a cache coherence protocol's abstract view of the underlying network.

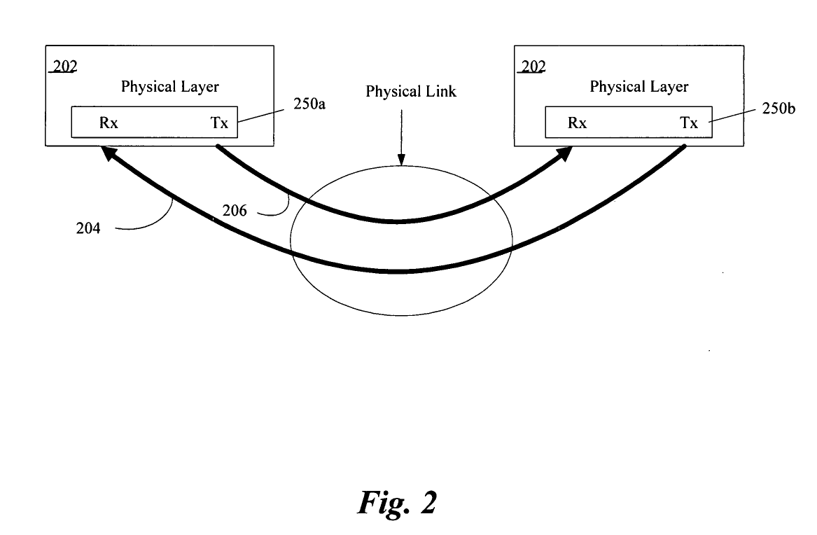

FIG. 2 is a block diagram of an apparatus for a physical interconnect utilized in accordance with embodiments of the invention described herein. In one aspect, the apparatus depicts a physical layer for a cache-coherent, link-based interconnect scheme for a processor, chipset, and/or IO bridge components. For example, the physical interconnect may be performed by each physical layer of an integrated device. Specifically, the physical layer provides communication between two ports over a physical interconnect comprising two uni-directional links. Specifically, one uni-directional link 204 from a first transmit port 250a of a first integrated device to a first receiver port 250b of a second integrated device. Likewise, a second unidirectional link 206 from a first transmit port 250b of the second integrated device to a first receiver port 250a of the first integrated device. However, the claimed subject matter is not limited to two uni-directional links. One skilled in the art will appreciate the claimed subject matter supports any known signaling techniques, such as, bi-directional links, etc.

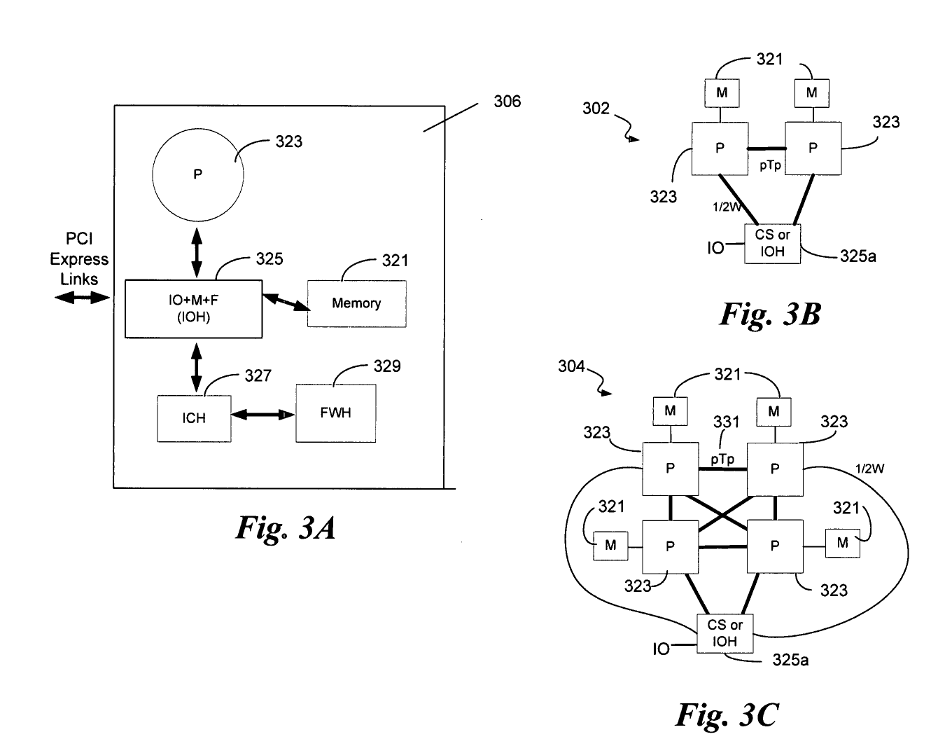

FIGS. 3A-C depict a point to point system with one or more processors. The claimed subject matter comprises several embodiments, one with one processor 306 (FIG. 3A), one with two processors (P) 302 (FIG. 3B) and one with four processors (P) 304 (FIG. 3C). In embodiments 302 and 304, each processor is coupled to a memory (M) 321 and is connected to each processor 323 via a network fabric which may comprise either or all of: a link layer, a protocol layer, a routing layer, a transport layer, and a physical layer. The fabric facilitates transporting messages from one protocol (home or caching agent) to another protocol for a point to point network. As previously described, the system of a network fabric supports any of the embodiments depicted in connection with FIGS. 1-3.

For embodiment 306, the uni-processor P 323 is coupled to graphics and memory control 325, depicted as IO+M+F, via a network fabric link that corresponds to a layered protocol scheme. The graphics and memory control is coupled to memory and is capable of receiving and transmitting via peripheral component interconnect (PCI) Express Links. Likewise, the graphics and memory control is coupled to the input/output controller hub (ICH) 327. Furthermore, the ICH 327 is coupled to a firmware hub (FWH) 329 via a low pin count (LPC) bus. Also, for a different uni-processor embodiment, the processor would have external network fabric links. The processor may have multiple cores with split or shared caches with each core coupled to an X-bar router and a non-routing global links interface. An X-bar router is a pTp interconnect between cores in a socket. X-bar is a “cross-bar” meaning that every element has a cross-link or connection to every other. This is typically faster than a pTp interconnect link and implemented on-die, promoting parallel communication. Thus, the external network fabric links are coupled to the X-bar router and a non-routing global links interface.

An embodiment of a multi-processor system (302, 304) comprises a plurality of processing nodes 323 interconnected by a point-to-point network 331 (indicated by thick lines between the processing nodes). For purposes of this discussion, the terms “processing node” and “compute node” are used interchangeably. Links between processors are typically full, or maximum, width, and links from processors to an IO hub (IOH) chipset (CS) 325a are typically half width. Each processing node 323 includes one or more central processors 323 coupled to an associated memory 321 which constitutes main memory of the system. In alternative embodiments, memory 321 may be physically combined to form a main memory that is accessible by all of processing nodes 323. Each processing node 323 may also include a memory controller 325 to interface with memory 321. Each processing node 323 including its associated memory controller 325 may be implemented on the same chip. In alternative embodiments, each memory controller 325 may be implemented on a chip separate from its associated processing node 323.

Each memory 321 may comprise one or more types of memory devices such as, for example, dual in-line memory modules (DIMMs), dynamic random access memory (DRAM) devices, synchronous dynamic random access memory (SDRAM) devices, double data rate (DDR) SDRAM devices, or other volatile or non-volatile memory devices suitable for server or general applications.

The system may also include one or more input/output (I/O) controllers 327 to provide an interface for processing nodes 323 and other components of the system to access to I/O devices, for instance a flash memory or firmware hub (FWH) 329. In an embodiment, each I/O controller 327 may be coupled to one or more processing nodes. The links between I/O controllers 327 and their respective processing nodes 323 are referred to as I/O links. I/O devices may include Industry Standard Architecture (ISA) devices, Peripheral Component Interconnect (PCI) devices, PCI Express devices, Universal Serial Bus (USB) devices, Small Computer System Interface (SCSI) devices, or other standard or proprietary I/O devices suitable for server or general applications. I/O devices may be wire-lined or wireless. In one embodiment, I/O devices may include a wireless transmitter and a wireless transmitter receiver.

The system may be a server, a multi-processor desktop computing device, an embedded system, a network device, or a distributed computing device where the processing nodes are remotely connected via a wide-area network.

In the embodiment as shown in FIG. 3C, network 331 provides partial connectivity for processing nodes 323. Thus, every processing node 323 is directly connected to some, but perhaps not all, of the other processing nodes. A processing node 323 is connected to another processing node via a direct link or via an indirect connection (e.g., using another processor as a go-between).

A type of message carried by network 331 is a snoop message, which contains information about a memory transaction that may affect the coherency state of a data item in caches (not shown). A memory transaction refers to a transaction that requires access to any memory device 321 or any cache. When any processing node performs a memory transaction, the processing node issues a snoop message (or equivalently, snoop request) on network 321 to request all of the other processing nodes to verify or update the coherency states of the data items in their respective local caches. I/O controllers 327 also issues and receives snoop messages when performing a direct memory access (DMA). Thus, any of processing nodes 323 and I/O controllers 327 may be a requesting node for a snoop message and a destination node for another snoop message.

When a first processing node sends a snoop message to a second processing node which is not directly connected to first processing node, the first and second processing nodes use a third processing node as a forwarding node. In this scenario, a third processing node serves as a forwarding node that forwards the snoop message to both processing the first and second processing nodes. The forwarding may be performed by a fan-out mechanism which replicates the incoming snoop message and forwards the replicated messages to different destinations.

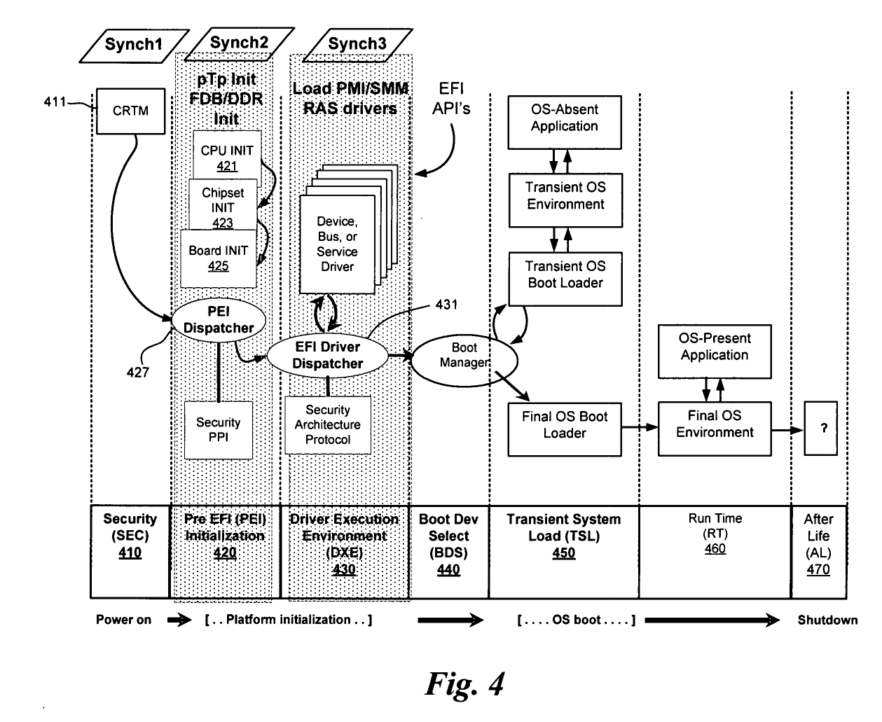

Referring now to FIG. 4, there is shown an illustration of the flow of execution of a system according to an embodiment of the invention. For purposes of discussion, focus will be on the processes required to boot the platform.

In existing multi-core systems, one processor is chosen to boot the platform, called the boot strap processor (BSP). Upon boot, the BSP will serially perform all boot tasks. Typically, in a platform having an extensible firmware interface (EFI) architecture, the security processing (SEC) 410 phase at “synch1” is executed during early boot.

A pre-verifier, or Core Root of Trust for Measurement (CRTM) 411 may be run at power-on and SEC phase 410. A pre-verifier is typically a module that initializes and checks the environment. In existing systems, the pre-verifier and SEC phase is the Core Root of Trust for Measurement (CRTM), namely enough code to startup the Trusted Platform Module (TPM) and perform a hash-extend of BIOS. More information on TPMs may be found at URL www*trustedcomputinggroup*org. The CRTM 411 launches the pre-EFI initialization (PEI) dispatcher 427 in the PEI phase 420, shown at “synch2.” Note that periods have been replaced with asterisks in URLs in this document to avoid inadvertent hyperlinks.

The processor 421, chipset 423 and board 425 may be initialized in the PEI stage 420. After PEI, the EFI Driver Dispatcher 431 and Intrinsic Services are launched securely in the driver execution environment (DXE) 430. Typically, the PEI dispatcher 427 launches the EFI driver dispatcher 431. The operations at the PEI phase 420 may be run from caches as RAM (CRAM) before proceeding to the driver execution environment (DXE) phase 430, shown at “synch3.” The OS boots at the transient system load (TDL) stage 450.

The boot device select (BDS) phase 440 is responsible for choosing the appropriate operating system. Upon a system failure during OS runtime (RT phase 460), such as what is referred to as BSOD (Blue Screen Of Death) in Windows® or Panic in Unix/Linux, the firmware PEI and DXE flows may be reconstituted in an after life (AL phase 470) in order to allow OS-absent recovery activities.

Bringing the platform to a full EFI runtime environment on each compute node has been typically done serially, by the BSP. For purposes of the discussion, a compute node may be a single socket or a collection of four sockets. In embodiments of the present invention, parallel processing among the cores is enabled during boot to launch multiple EFI instances among the compute nodes. In existing systems, this was typically performed serially, and late in the boot process. In the discussion below, a compute node is typically referring to one socket. Each socket may have multiple cores, however, only one instance of EFI will run on each socket.

A policy may exist from the platform administrator to define 32 processors, but 16 are to be booted on one OS and the other 16 are to boot with another OS, for instance utilizing a hardware partition. DXE drivers may communicate with one another to implement the platform policy decisions. By deferring synchronization late into the DXE phase, policy decisions and partitioning can be made more efficiently. In existing systems the join (non-partitioned) or split (partitioned) is performed early in the PEI phase.

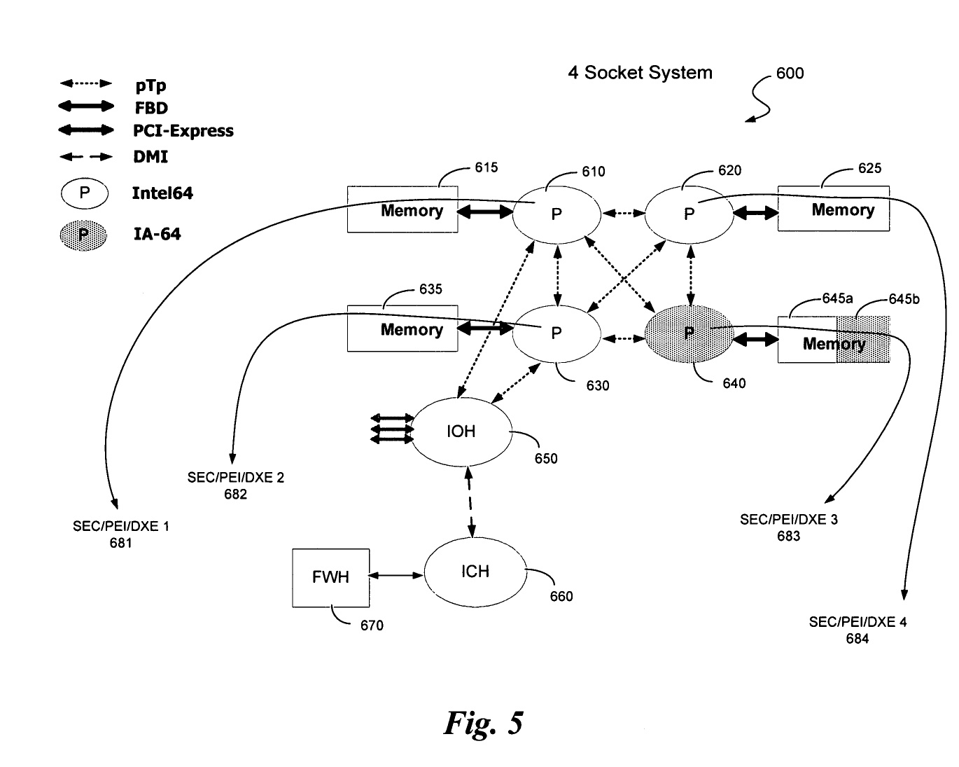

FIG. 5 illustrates a four-socket system 600 according to an embodiment of the invention. Processors 610, 620, 630 and 640 may include any number of cores. In this exemplary embodiment, processing nodes 610, 620 and 630 comprise a first processing architecture, for instance a Xeon® Processor architecture. Processing node 640 represents a second processor architecture, for instance from the Itanium® Processor Family (IPF) of microprocessors. Each of the processors 610, 620, 630 and 640 has a memory coupled to it, 615, 625, 635 and 645, respectively. The dotted lines between processors indicated a pTp interconnect bus. The bolded lines between a processor and its memory indicate a fully buffered DIMM (FBD) or double data rate (DDR-2) connection, depending on memory type. Some of the processors, 610 and 630 in this example, may be connected to an input/output hub (IOH) 650 via the pTp interconnect bus. Existing (non-pTp platforms) typically have north bridge (memory controller hub) and south bridge Input/Output controller (ICH). In an embodiment using pTp architecture, the IOH 650 may replace the MCH and front side bus. In this case, the memory controllers may be built into the processor nodes. The IOH 650 may be coupled with a number of devices (not shown) via a number of peripheral component interconnect express (PCI-e) buses, as indicated by grey lines. The IOH 650 is coupled to the input/output controller hub (ICH) 660, via a direct media interface (DMI) bus, as shown with dashed lines. The IOH 650 receives pTp interconnect protocol communication from the processing nodes and communicates with the ICH 660 via I/O bus protocols. The ICH 660 may be coupled to a firmware hub (FWH) 670. The FWH 670 will typically store the various boot code.

In this exemplary embodiment, each processor/memory pair is a compute node in a socket. In an embodiment, the advanced configuration and power management (ACPI) tables may be customized to identify proximity information for the memory. Existing systems may use an ACPI SLIT (System Locality Information Table), but the SLIT assumes homogenous compute elements. A new table, hSLIT, for heterogeneous SLIT, may be generated to allow for naming the different compute elements. More information about ACPI SLIT tables may be found in an article entitled “Operating System Multilevel Load Balancing” by M. Zorzo and R. Scheer, located on the public Internet at www*inf*pucrs*br/peso/SAC.pdf. For instance, memory 625 is closer to processor 620 than it is to processor 630. Non-uniform memory access (NUMA) processing will use this information. It is desirable for code running on a given processor to have memory allocated to it that is physically “closer.” The closer proximity enables applications run faster. Local memory access may be 120 nanoseconds/data read vs. 360 nanoseconds to access a remote page a memory. Each compute node may parallelize boot by simultaneously executing the boot phases SEC/PEI/DXE with the other compute nodes. Once the SEC/PEI.DXE phases are completed for each compute node, the boot device select (BDS) phase 440 may commence. The BDS phase 440 is where partitioning and boot decisions are to be made, and where the compute nodes may be joined. For instance, if the platform policy requires only one instance of Microsoft® Windows® to run on the platform, only one processor will boot Windows®. In BDS 440, one processor, for instance 610 collects data from the other processors 620, 630 and 640 and then processor 610 boots the system and launches Windows®.

In an embodiment, memory 645 is logically partitioned into two segments 645a-b. For instance, when processor 640 is an Itanium® processor to be used as the equivalent of a math co-processor, memory 645b is logically partitioned to be solely accessible by processor 640. The platform OS executes on one or more of the processors 610, 620 or 630 and has access only to memory partition 645a.

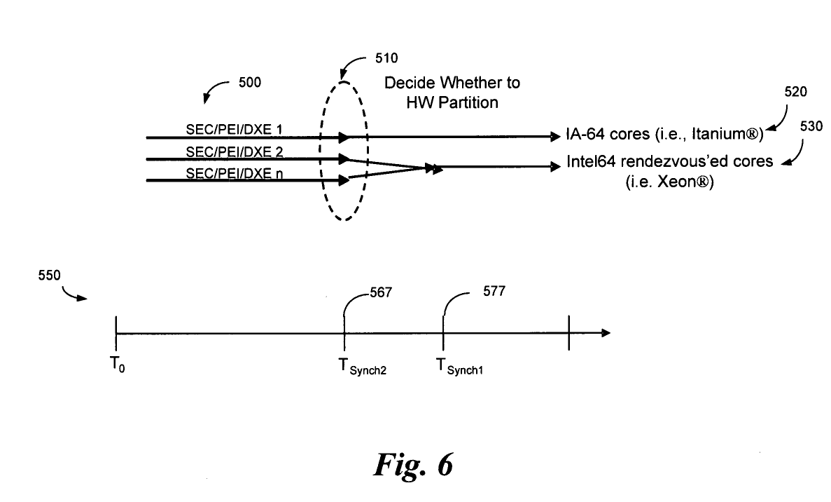

FIG. 6 illustrates a synchronization timeline for an exemplary embodiment of the invention. In an embodiment, the platform has both IA-64 processors and Intel64 processors. The boot process for the disparate processors is different. However, both boot codes are present on the platform's firmware flash memory. The timeline 550 shows various synchronization points in the boot phase. In an embodiment, the SEC phase begins on each processor (compute node) on the platform. A rendezvoused compute node is a multi-core node where one core is selected to boot the node. The boot phases SEC/PEI/DXE 500 execute in parallel on each compute node 1 . . . n with the disparate processors executing variant code appropriate for their architecture.

The boot entry point in the flash, or boot media, for Itanium® processors is 4 Gbyte-64 bytes, whereas for an Intel64 processor it is 4G-16 bytes. As such, each compute element “begins” execution in a different portion of the flash, or boot media. The above-identified co-pending patent application by Khanna discusses how best to organize the boot media to accommodate two sets of BIOS code. The varying entry point is defined the Itanium® and Pentium4® processor manuals which may be found on the public Internet at www*intel*con/design/itanium/manuals/iiasdmanual.htm and www*intel*com/design/Pentium4/documentation.htm, respectively.

At time T_{synch2} 567, a determination is made whether to partition or join compute nodes from selected sockets (at 510). In this example, the IA-64 processing cores 520 are selected to be joined (if more than one processor), and to share common memory via the pTp interconnect. Compute nodes 2 . . . n are Intel64 rendezvoused cores, and are partitioned separately from the IA-64 compute nodes but joined with each other at T_{sycnh1} 577. The boot process continues at 577 and the operating system(s) are launched for each partitioned set of compute nodes.

Existing systems cannot deploy heterogeneous systems, for instance mixing Xeon® and Itanium® processors because they use different, and incompatible methods for managing cache consistency. The Xeon® processors support home-based messages for caching and Itanium® processors support directory-based messages for caching. However, mixing these processors on a single platform may be desirable because they both have advantages that complement the other. For instance, Itanium® processors excel at floating point operations.

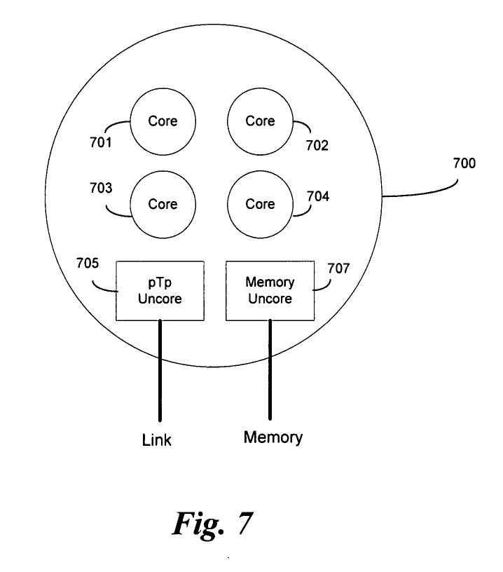

In embodiments of the invention, a compute node comprises a processor and memory in a socket on the platform. FIG. 7 illustrates a compute node architecture that will accommodate a common messaging system. The compute node 700 is a multi-core processor. In this example, the compute node has four processor cores 701-704. It will be apparent by those of skill in the art that a dual-core processor or a many-core (more than four) processor may be implemented as compute node 700. Four cores are merely used to illustrate on aspect of the invention. The compute node 700 also comprises two additional cores that are referred to as “uncores” because they are not processors. In this example, the first uncore is the pTp uncore 705. This component is used to link the compute node to the pTp network, including processor cache. The memory uncore 707 is merely a component of memory, optionally including a memory controller, within the compute node, and having no processor core. In future deployments of processors using pTp interconnects, it is expected that cache messaging will use a common form, utilizing the pTp uncore 707. Existing processors may have a socket fitted with a compute node as described herein to harmonize the cache messaging to the proper architecture.

In another embodiment, the compute node may comprise memory uncores with no processor cores (not shown). In this embodiment, additional memory is more desirable than additional processors for a selected socket. In this case, the compute node which is more accurately a “memory node,” comprises one or more memory uncores 707 and a pTp uncore 705 to allow access to the memory using the pTp interconnect bus. In some embodiments, the memory node further comprises memory controller logic (not shown). In other embodiments, the memory controller is external to the node and may be coupled to the chipset.

In a platform deployed with Intel® Xeon® processors, the pTp uncore in 705 uses a cache-coherency mechanism called “home based”, whereas on Itanium® processor systems the pTp uncore uses “directory based.” The “home based” mechanism is equivalent to the “snoopy message based” mechanism, as discussed above. The other mechanism is directory based. Snoopy based, or home based, methods are less scalable for a large number of processors. In an embodiment of a heterogeneous platform with both processor types, for a small number of compute nodes connected via a pTp network, one compute node 700 will be designated as the “home” and any questions of whether a cache line is “dirty,” or in any of the other cache-states of the MESIF protocol (Modified-Exclusive-Shared-Invalid-Forward) will be arbitrated by the home nodes. More information about cache states may be found in “The Cache Memory Book”, Second Edition by Jim Handy (Academic Press Inc. 1998).

Home based cache messaging is fast, but scales only to a small number of compute nodes. This method also tends to be less expensive because one of the compute nodes is the “home” agent at all times. Directory based cache messaging is more scalable to large systems and requires an external chipset (such as IOH) to be the directory. Adding this extra hardware to implement Directory Based cache messaging is more expensive, but allows the pTp network to scale to hundreds, or thousands of compute nodes.

For the heterogeneous multi-processing to be viable, the pTp uncore 705 for both the Xeon® & Itanium® cores need to either be all “home” based or all “directory” based. In one embodiment with a small number of compute nodes, all of the pTp uncores are implemented as Home based. In another embodiment to support a large number of compute nodes, the pTp uncores are implemented as Directory based. In both cases, it is important that all of the pTp uncores 705 for all compute nodes in the platform are implemented with the same cache messaging architecture.

It is foreseeable that manufacturers, such as Intel Corp., will deploy stock keeping units (SKUs) for platforms that comprise either “home” or “directory” based cache messaging for pTp uncores 705 to support this type of heterogeneous MP topology in the future.

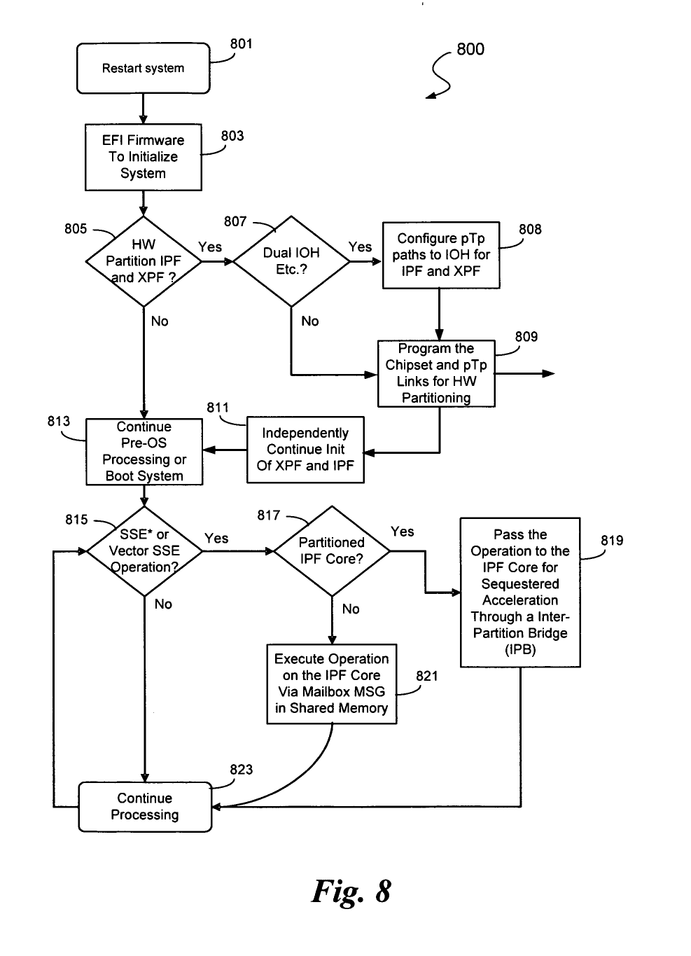

Referring now to FIG. 8, there is shown an exemplary method 800 for booting heterogeneous processors in a platform conforming to pTp interconnect architecture, according to an embodiment of the invention. The system is restarted in block 801. Extensible Firmware Interface (EFI) Initialization of the platform begins in block 803. A determination is made in block 805 as to whether a hardware partition is to be made for two processor types, (in this example, IPF and XPF). If there is to be a hardware partition, then a determination is made as to whether there are dual IOH components in block 807. If so, then the pTp interconnect paths are configured to each IOH from the IPF and XPF processor, in block 808. In either case, the chipset and pTp interconnect links are then programmed for hardware partitioning, in block 809. The boot and initialization phases may then continue independently on the IPF and XPF processors in the platform, in block 811. Regardless of whether there is to be partitioning, as determined in block 805, pre-OS processing continues and the system is booted in block 813.

Runtime use of the heterogeneous processors, is illustrated by an example platform having three Xeon® processor nodes (610, 620 and 630) and one Itanium processing node 640 for executing complex floating point, SSE calculations, data-mining, disk sorting, cryptography or other complex operations. FIG. 8 shows an XPF-centric flow of runtime. During runtime, a determination is made as to whether a streaming SIMD (single instruction multi data) extensions (SSE) or Vector SSE operation is to be executed in decision block 815. These types of instructions are more efficiently executed on IPF processors. If we have a partitioned heterogeneous platform with both XPF and IPF processors, as determined in decision block 817, then this instruction (or series of instructions) are passed to the IPF core for sequestered acceleration, in block 819. These instructions and results may be passed via an inter-partition bridge (IPB). If the platform has an IPF core, but it is not hardware partitioned, i.e., software sequestering, then the operations may be executed on the IPF core via a mailbox message in shared memory, in block 821. Processing continues at block 823 until a new SSE or vectored SSE operation is requested, as determined at 815.

Running parallel boot phases on each compute node enables partition readiness in the platform. Once the parallel booting is complete, each partition proceeds to launch its own OS and no further action is required. In many cases full hardware partitioning is preferable to software partitioning because it is more secure. However, embodiments of the present invention may be implemented with software sequestering. In systems deployed on a pTp interconnect architecture platform, a compute node may be purposely left unconnected with other specific compute nodes to ensure secure partitioning. Policies to effect this may be programmed into the platform firmware.

Embodiments of the present invention may be more fault tolerant than existing systems. When booting is performed in parallel on each compute node, errors or failure of a compute node may be detected before the nodes are fully joined or partitioned. Platform policy may dictate what corrective action is to be taken in the event of a node failure. Thus, if one or more parallel boot agent fails, booting can still complete with subsequent OS launch(es).

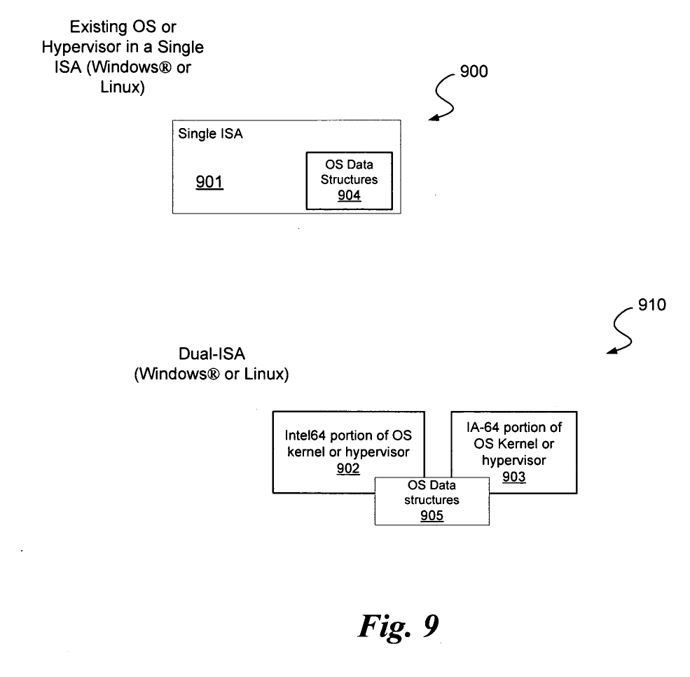

In addition to the co-processor model for heterogeneous systems, as discussed above, an alternative embodiment uses heterogeneous multi-processors to create a dual-ISA environment. The exemplary four-socket system of 600 may be configured at runtime to run a single-system image (SSI) operating system. This means that all cores of both processor architecture types are managed by a single executive entity, such as a Type I or Type II virtual machine monitor (where Type I is the “hypervisor”—like, and Type II is a “hosted” model), or a base metal OS kernel. FIG. 9 illustrates a homogeneous, single-ISA system 900 and a dual-ISA system 910. In existing systems, the kernel or hypervisor is compiled down to a single instruction set architecture (e.g., Intel64 or IA-64) at 901. The single-ISA 901 comprises a set of code in the kernel and the OS or hypervisor data structures 904, such as thread-control blocks, permissions, and other flags/state information.

Cache-coherency between the compute nodes enables a single system image OS to manage processors with different ISAs, if coded to comprehend these heterogeneous resources. A decomposed OS that has a portion of the kernel or hypervisor compiled to the alternate ISA's is shown at 902 and 903. The first ISA kernel may be an Intel64 architecture 902 and the second ISA kernel may be IA-64 architecture 903. The pTp interconnect bus and uncores allow for cache-coherency so that 902 and 903 can seamlessly share OS data structures 905.

With the OS case, applications may be written in Intel64 or IA-64 and designated by the kernels 902 and 903 to only run on the Intel64 or IA-64 hardware. For the hypervisor case, guest operating systems written in Intel64 may be managed by the 902 portion of the hypervisor and guest operating systems written in IA-64 may be managed by the 903 portion of the hypervisor.

In another alternative embodiment, the co-processor model and dual-ISA model a combined to create a hybrid model. In an exemplary embodiment, the four socket system 600 of FIG. 5, two processors of the first type and two processors of the second type, e.g., compute node 630 is also an Itanium® processor. In this embodiment, compute node 640 continues to be partitioned and act like a co-processor for complex operations. However, compute node 630 is joined with compute nodes 610 and 620 during boot time to operate under a single OS for handling heterogeneous ISAs. It will be apparent to one of skill in the art that this embodiment may be scaled to more than the exemplary four sockets.

The techniques described herein are not limited to any particular hardware or software configuration; they may find applicability in any computing, consumer electronics, or processing environment. The techniques may be implemented in hardware, software, or a combination of the two.

For simulations, program code may represent hardware using a hardware description language or another functional description language which essentially provides a model of how designed hardware is expected to perform. Program code may be assembly or machine language, or data that may be compiled and/or interpreted. Furthermore, it is common in the art to speak of software, in one form or another as taking an action or causing a result. Such expressions are merely a shorthand way of stating execution of program code by a processing system which causes a processor to perform an action or produce a result.

Each program may be implemented in a high level procedural or object-oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods.

Program code, or instructions, may be stored in, for example, volatile and/or non-volatile memory, such as storage devices and/or an associated machine readable or machine accessible medium including solid-state memory, hard-drives, floppy-disks, optical storage, tapes, flash memory, memory sticks, digital video disks, digital versatile discs (DVDs), etc., as well as more exotic mediums such as machine-accessible biological state preserving storage. A machine readable medium may include any mechanism for storing, transmitting, or receiving information in a form readable by a machine, and the medium may include a tangible medium through which electrical, optical, acoustical or other form of propagated signals or carrier wave encoding the program code may pass, such as antennas, optical fibers, communications interfaces, etc. Program code may be transmitted in the form of packets, serial data, parallel data, propagated signals, etc., and may be used in a compressed or encrypted format.

Program code may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, each including a processor, volatile and/or non-volatile memory readable by the processor, at least one input device and/or one or more output devices. Program code may be applied to the data entered using the input device to perform the described embodiments and to generate output information. The output information may be applied to one or more output devices. One of ordinary skill in the art may appreciate that embodiments of the disclosed subject matter can be practiced with various computer system configurations, including multiprocessor or multiple-core processor systems, minicomputers, mainframe computers, as well as pervasive or miniature computers or processors that may be embedded into virtually any device. Embodiments of the disclosed subject matter can also be practiced in distributed computing environments where tasks or portions thereof may be performed by remote processing devices that are linked through a communications network.

Although operations may be described as a sequential process, some of the operations may in fact be performed in parallel, concurrently, and/or in a distributed environment, and with program code stored locally and/or remotely for access by single or multi-processor machines. In addition, in some embodiments the order of operations may be rearranged without departing from the spirit of the disclosed subject matter. Program code may be used by or in conjunction with embedded controllers.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A platform having heterogeneous processors, comprising:
a first compute node comprising at least one processing core of a first architecture type, wherein the first compute node has associated memory, and wherein the first compute node further comprises an uncore for point to point (pTp) interconnectivity communication;
a second compute node comprising at least one processing core of a second architecture type, wherein the second compute node has associated memory, and wherein the second compute node further comprises an uncore for point to point (pTp) interconnectivity communication;
a point to point (pTp) interconnect bus to allow communication between and among the compute nodes having processing cores of the first and second architecture type and to an input output hub (IOH); and
a firmware hub comprising non-volatile memory, the memory having boot phase instructions stored therein, the boot phase instructions comprising a first set of boot instructions to boot the processors of the first architecture type and a second set of boot instructions to boot the processors of the second architecture type,
wherein the pTp uncores for the compute nodes of both the first and second architectures types are configured to use a same cache messaging protocol.

2. The platform as recited in claim 1, further comprising at least one memory node communicatively coupled to at least one compute node via the pTp interconnect bus, the memory node comprising at least one memory uncore and a pTp uncore.

3. The platform as recited in claim 2, wherein the at least one memory node further comprises a memory controller.

4. The platform as recited in claim 1, wherein at least one compute node of the first or second type further comprises a memory uncore.

5. The platform as recited in claim 4, wherein the at least one compute node of the first or second type having a memory uncore further comprises a memory controller.

6. The platform as recited in claim 1, wherein the pTp uncores are configured to use a home based cache messaging protocol, wherein one compute node on the platform is designated as the “home.”

7. The platform as recited in claim 1, wherein the pTp uncores are configured to use a directory based cache messaging protocol, wherein an external chipset is designated as the directory.

8. The platform as recited in claim 1, wherein the first processor architecture type comprises processors from the Intel® Xeon® processor family and the second processor architecture comprises processors from the Intel® Itanium® processor family.

9. The platform as recited in claim 1, wherein each set of boot instructions comprise a security (SEC) phase, a pre-extensible interface firmware (EFI) initialization (PEI) phase, and a driver execution (DXE) phase, wherein the set of SEC, PEI and DXE phases are to run in parallel on each compute node during boot.

10. The platform as recited in claim 1, wherein the first compute node is to be joined with other like compute nodes on the platform, the first architecture type compute nodes sharing a common memory map, and the second compute node is to be partitioned from the compute nodes of the first processor architecture type by a boot device select (BDS) phase to execute after the SEC, PEI and DXE phases are completed.

11. The platform as recited in claim 10, wherein the partitioning is implemented in one of hardware or software.

12. The platform as recited in claim 10, wherein the second compute node is to be used for selected complex operations, the operations selected from the group of instructions consisting of floating point, streaming SIMD (single instruction multi data) extensions (SSE), Vector SSE operations, data-mining operations, disk sorting operations, and cryptographic operations.

13. The platform as recited in claim 10, wherein the associated memory of the second compute node comprises locally coupled partitioned memory having a first partition accessible to the first compute node and having a second partition inaccessible to the first compute node, the second partition being accessible to the second compute node.

14. The platform as recited in claim 1, wherein the associated memory of a compute node on the platform is locally coupled memory, the compute node being one of the first or second processor architecture types.

15. The platform as recited in claim 1, further comprising a third compute node, wherein the associated memory of the third compute node on the platform is remote memory to the third compute node, and local memory to at least one of the first and second compute nodes, the associated memory being accessible via the pTp interconnect bus through the pTp uncores, wherein the third compute node is of a same architecture type of either the first or second compute node, and wherein the third compute node comprises only processing cores and no memory uncores.

16. The platform as recited in claim 1, further comprising at least one additional compute node of the first architecture type.

17. The platform as recited in claim 1, wherein the first compute node is to be joined with at least one unlike compute node on the platform, the first compute node and the unlike compute node sharing a common memory map, the joining to be implemented by a boot device select (BDS) phase to execute after the SEC, PEI and DXE phases are completed.

18. The platform as recited in claim 17, wherein the at least one unlike compute node comprises at least a third compute node comprising at least one processing core of the second architecture type, wherein the third compute node further comprises an uncore for point to point (pTp) interconnectivity communication, and wherein the second compute node is to be partitioned from the joined compute nodes, the partitioning to be performed by a boot device select (BDS) phase to execute after the SEC, PEI and DXE phases are completed.

19. The platform as recited in claim 18, wherein the partitioning is implemented in one of hardware or software.

20. The platform as recited in claim 18, wherein the second compute node is to be used for selected complex operations, the operations selected from the group of instructions consisting of floating point, streaming SIMD (single instruction multi data) extensions (SSE), Vector SSE operations, data-mining operations, disk sorting operations, and cryptographic operations.

21. The platform as recited in claim 18, wherein the associated memory of the second compute node comprises locally coupled partitioned memory having a first partition accessible to the first compute node and having a second partition inaccessible to the first compute node, the second partition being accessible to the joined compute nodes.

22. The platform as recited in claim 10, wherein the common memory map is generated based on proximity information stored in an ACPI table.

23. The platform as recited in claim 17, wherein the common memory map is generated based on proximity information stored in an ACPI table.

24. A method for heterogeneous multiprocessing, comprising:
booting a first and second processor on a multi-processor platform, the first and second processor being of unlike architecture types, wherein each of the first and second processor have associated boot code residing in memory on the platform, and wherein the first and second processor are configured to use a common cache messaging protocol;
executing a first set of instructions on the first processor in the platform, the first processor being of a first architecture type and having associated memory;
passing a complex operation to be executed in the first set of instructions from the first processor to a second processor in the platform, the second processor being of a second architecture type and configured to process the complex operation more efficiently than the first processor;
executing the complex operation on the second processor; and
passing results of the complex operation to the first processor,
wherein the first and second processor each comprise at least one processing core and a point to point interconnect (pTp) uncore for interconnectivity communication among processors and memory on the platform.

25. The method as recited in claim 24, wherein booting the first and second processor comprises booting the first and second processor in parallel for a security (SEC), pre-extensible firmware interface (EFI) initialization (PEI) phase, and a driver execution (DXE) phase; and
joining processors of the first architecture type and partitioning processors of the second architecture type from the processors of the first architecture type after executing the SEC, PEI and DXE boot phases, wherein partitioning is one of hardware partitioning or software sequestering.

26. The method as recite in claim 24, wherein second processor is configured to be capable of being a host processor on the platform, when dictated by platform policy.

27. The method as recited in claim 24, wherein the passing of a complex operation is via an inter-partition bridge when the partitioning is hardware partitioning, and wherein the passing of a complex operation is via a mailbox message in shared memory when the partitioning is software sequestering.

28. The method as recited in claim 24, wherein the complex operation comprises an instruction selected from the group of instructions consisting of floating point, streaming SIMD (single instruction multi data) extensions (SSE) and Vector SSE operations.

29. The method as recited in claim 24, wherein the first processor architecture type comprises processors from the Intel® Xeon® processor family and the second processor architecture comprises processors from the Intel® Itanium® processor family.

30. The method as recited in claim 24,
enabling by the pTp uncore, like cache messaging in unlike processors, wherein the cache messaging uses one of a home-base or directory-based protocol.

31. A machine readable medium for heterogeneous multiprocessing, the medium having instructions stored therein that when executed cause a machine to:
boot a first and second processor on a multi-processor platform, the first and second processor being of unlike architecture types, wherein each of the first and second processor have associated boot code residing in memory on the platform, and wherein the first and second processor are configured to use a common cache messaging protocol;
execute a first set of instructions on the first processor in the platform, the first processor being of a first architecture type and having associated memory;
pass a complex operation to be executed in the first set of instructions from the first processor to a second processor in the platform, the second processor being of a second architecture type and configured to process the complex operation more efficiently than the first processor;
execute the complex operation on the second processor; and
pass results of the complex operation to the first processor,
wherein the first and second processor each comprise at least one processing core and a point to point interconnect (pTp) uncore for interconnectivity communication among processors and memory on the platform.

32. The medium as recited in claim 31, wherein booting the first and second processor comprises further instructions to:
boot the first and second processor in parallel for a security (SEC), pre-extensible firmware interface (EFI) initialization (PEI) phase, and a driver execution (DXE) phase; and
join processors of the first architecture type and partitioning processors of the second architecture type from the processors of the first architecture type after executing the SEC, PEI and DXE boot phases, wherein partitioning is one of hardware partitioning or software sequestering.

33. The medium as recite in claim 31, wherein second processor is configured to be capable of being a host processor on the platform, when dictated by platform policy.

34. The medium as recited in claim 31, wherein the passing of a complex operation is via an inter-partition bridge when the partitioning is hardware partitioning, and wherein the passing of a complex operation is via a mailbox message in shared memory when the partitioning is software sequestering.

35. The medium as recited in claim 31, wherein the complex operation comprises an instruction selected from the group of instructions consisting of floating point, streaming SIMD (single instruction multi data) extensions (SSE), Vector SSE operations, data-mining operations, disk sorting operations, and cryptographic operations.

36. The medium as recited in claim 31, wherein the first processor architecture type comprises processors from the Intel® Xeon® processor family and the second processor architecture comprises processors from the Intel® Itanium® processor family.

37. The medium as recited in claim 31, further comprising instructions to enable by the pTp uncore, like cache messaging in unlike processors, wherein the cache messaging uses one of a home-base or directory-based protocol.

38. A method for heterogeneous multiprocessing, comprising:
booting a platform having at least one processor of a first architecture type and at least one processor of a second architecture type, wherein the first and second architecture types are unlike architecture types comprising unlike instruction set architectures (ISAs) and requiring unlike boot code, wherein a first boot code corresponding the first architecture type and a second boot code corresponding to the second architecture type are resident on a boot media for the platform, wherein the first and second processor architecture types are configured to use a common cache messaging protocol; and
joining at least one of the at least one processor of a first architecture type and at least one of the at least one processor of a second architecture type prior to launching an operating system, wherein joining the processors puts the joined processors under control of a single operating system,
wherein processors of both the first and second processor architecture type comprise at least one processing core and a point to point interconnect (pTp) uncore for interconnectivity communication among processors and memory on the platform.

39. The method as recited in claim 38, further comprising:
booting at least one additional processor, the at least one additional processor being of either the first or second processor architecture type; and
partitioning the at least one additional processor from the joined processors, wherein the partitioning is implemented in one of hardware or software.

40. The method as recited in claim 29, further comprising:
executing a first set of instructions under the operating system of the joined processors;
passing a complex operation to be executed in the first set of instructions from the joined processor execution to the partitioned at least one of the additional processor, wherein the partitioned at least one processor is configured to process the complex operation more efficiently than the joined processors;
executing the complex operation on the partitioned at least one additional processor; and
passing results of the complex operation to the joined processors.
